(19) United States
(12) Patent Application Publication
(10) Pub. No.: US 2002/0015536 A1
(43) Pub. Date: Feb. 7, 2002

(54) Apparatus and method for color image fusion

(76) Inventors: Penny G. Warren, Washington, DC (US); Jonathon M. Schuler, Annandale, VA (US); Dean Scribner, Arlington, VA (US); Richard B. Klein, Falls Church, VA (US); John G. Howard, Haymarket, VA (US); Michael P. Satyshur, Davidsonville, MD (US); Melvin R. Kruer, Fort Washington, MD (US)

Correspondence Address: NAVAL RESEARCH LABORATORY, ASSOCIATE COUNSEL (PATENTS), CODE 1008.2, 4555 OVERLOOK AVENUE, S.W., WASHINGTON, DC, 20375-5320, US

(21) Appl. No.: 09/840,235

(22) Filed: Apr. 24, 2001

Related U.S. Application Data
(60) Provisional application No. 60/199,127, filed on Apr. 24, 2000.

(51) Int. Cl. G06K 9/00; G06K 9/36

(52) U.S. Cl. 382/284; 382/162

(57) ABSTRACT

An apparatus for processing imaging data in a plurality of spectral bands and fusing the data into a color image includes one or more imaging sensors and at least two image-acquiring sensor areas located on the imaging sensors. Each sensor area is sensitive to a different spectral band than at least one of the other sensor area or areas, and each sensor area will generate an image output representative of an acquired image in the spectral band to which it is sensitive. The apparatus further includes a software program that runs on a computer and executes a registration algorithm for registering the image outputs pixel-to-pixel, an algorithm to scale the images into a 24-bit true color image for display, and a color fusion algorithm for combining the image outputs into a single image. The system architecture and software includes the registration and color fusion algorithms and preferably a color monitor for displaying an operator interface that includes pull-down menus to facilitate a terminal operator carrying out registration and/or adjustment of the scaled and other images on-screen in order to produce a desired color fusion image output.

The present application claims the benefit of the priority filing date of provisional patent application Ser. No. 60/199,127, filed Apr. 24, 2000.

### BACKGROUND OF THE INVENTION

1. Field of the Invention

This invention relates to an apparatus and method for the acquiring and color fusion of an image with improved properties. More particularly, the invention relates to acquiring and processing an image multi-spectrally.

2. Description of the Related Art

Scanning sensors such as military forward-looking infrared sensors (FLIR) can provide a 2-D image array for the purpose of visual interpretation. Until recently, imaging sensors operating in regions of the electromagnetic (EM) spectrum beyond the visible were typically used in special applications, such as remote sensing and military systems, that tolerated high cost and complexity. With costs dropping of infrared (IR) sensors, potential affordable applications, e.g. in areas such as transportation and security systems employing computer vision systems, are increasing. As a consequence of the falling costs of IR sensors, it has become more common to include multiple sensors in different bands in a single data collection system. Normally, the images from these sensors are displayed as black and white images on individual displays.

Color fusion provides a technique for displaying the data from multiple sensors in a single color image. These color images exploit the full ability of human color vision, unlike black and white display images. The most common method to create fused imagery is to use common optics in the optical path of the sensors. This hardware solution allows creation of parallel stream of data from the sensors that are registered. These parallel streams of data are then combined to form a composite color image. This is an expensive solution because common optics must be custom-made for each system. Also, this approach is very rigid, not allowing changes to be easily made to the system. In this method, the intensity values of the pixels of the images are not available for processing or examination.

The fusion method described here is distinguished from video overlay, in which video signals from multiple cameras, which might not have common optics, are combined without pixel to pixel registration, directly into a monitor. Also in this method, the intensity values of the pixels of the images are not available for processing or examination.

Color fusion here described as a technique for displaying imagery, e.g. IR imagery, is distinguishable from other types of image fusion currently under study having fundamentally different goals. Some other color fusion algorithms attempt to combine images by applying criteria such as good regional contrast between scene constituents or the rejection of noisy or low contrast image segments, producing a single mosaic image rather than image in which each pixel contains information from each input image. Although some systems were developed to store imagery to a hard disk or VCR in real time, the imagery from multiple cameras could not be fused and displayed in real time.

There is therefore a need for a color fusion technique and apparatus capable of providing real-time data in a digital representation in a form that yields three colors, i.e. spectral bands, for human interpretation. Recent advances in sensor technology, e.g. large format staring IR focal plane arrays (FPA), digital visible, near infrared (NR) cameras, low light level (LLL) and image intensified (I2) technology, make it possible to optimize and/or combine the assets of visible and other spectral bands. There is a need to apply these new advances in this area of application.

### SUMMARY OF THE INVENTION

According to the invention, an apparatus for processing imaging data in a plurality of spectral bands and fusing the data into a color image includes one or more imaging sensors and at least two image-acquiring sensor areas located on the imaging sensors. Each sensor area is sensitive to a different spectral band than at least one of the other sensor area or areas, and each sensor area will generate an image output representative of an acquired image in the spectral band to which it is sensitive. The apparatus further includes a software program that runs on a computer and executes a registration algorithm for registering the image outputs pixel-to-pixel, an algorithm to scale the images into a 24-bit true color image for display, and a color fusion algorithm for combining the image outputs into a single image. The apparatus further includes the system architecture and the software that includes the registration and color fusion algorithms. The color fusion system also preferably includes a frame grabber and a general purpose computer in which the registration algorithm and the color fusion algorithm are resident programs. The system also preferably includes a screen display, e.g. a color monitor, for displaying an operator interface/pull-down menus to facilitate a terminal operator carrying out registration and/or adjustment of the scaled and other images on-screen in order to produce a desired color fusion image output. The invention also includes the method, further described and claimed below, of using the apparatus/system.

The invention provides real-time imaging in virtually any desired combination of spectral bands based on multiple sensor outputs. These can include all visible, visible combined with SWIR (those cameras sensitive to wavelengths longer than the visible wavelengths, 0.9 microns, but shorter than 3.0 microns), MWIR (those cameras sensitive to wavelengths near the carbon dioxide absorption band in the atmosphere, approximately between 3.0 to 5.0 microns), LWIR (those cameras sensitive to wavelengths longer than 7.0 microns) and other variations as may be desirable for a given application.

The invention further provides a color fusion system and method that produces a viewable image with better scene comprehension for a viewer. The imagery that is achieved exhibits a high degree of target to background contrast for human visualization. The image generated shows good signal-to-noise ratio (SNR), and the information from each band is present in all pixels of the final image.

The invention is useful in military applications, for example for sensor fusion in targeting and situational awareness platforms such as rifle sites and aircraft landing and take-off monitoring systems. The color fusion system and method also has non-military applications, for example in medical imaging, quality control by product monitoring in manufacturing processes, computer-based identification systems for locating or identifying persons, animals, and vehicles and the like, and security surveillance, to name but a few.

### BRIEF DESCRIPTION OF THE DRAWINGS

FIG. 1 is a block diagram illustration of a color fusion system according to the invention.

FIG. 2 is a schematic illustration of parameters adjusted in practicing an embodiment of the invention that applies a particular color fusion technique (PCCF) according to the invention.

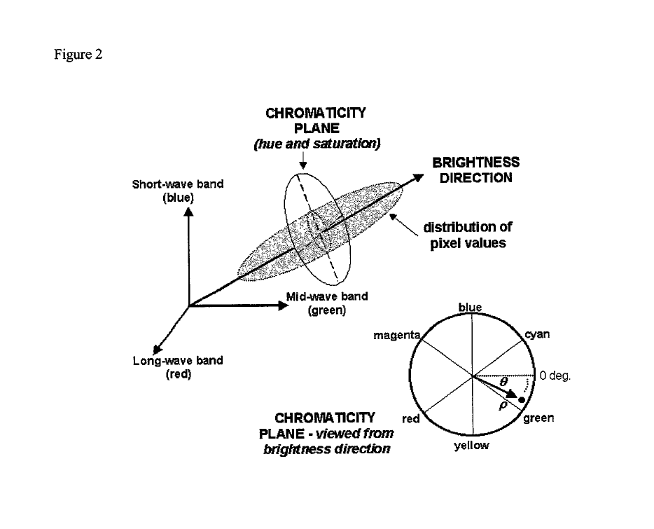

FIG. 3 is a block diagram illustration of a color fusion system according to the invention.

FIG. 4 is a block diagram illustration of a color fusion system according to the invention.

FIG. 5 is a representative on-screen display of an operator interface according to the invention.

FIG. 6 is a representative on-screen display of an operator interface according to the invention.

FIG. 7 is a representative on-screen display of an operator interface according to the invention.

FIG. 8 shows raw and scaled images illustrative of image-processing according to the invention.

FIG. 9 shows raw, scaled, and fused images produced in practicing the invention.

FIG. 10 shows a real-time example of registration during image-processing in the practice of the invention.

FIG. 11 shows a comparison of registered images using three different color fusion algorithms according to the invention.

### DETAILED DESCRIPTION

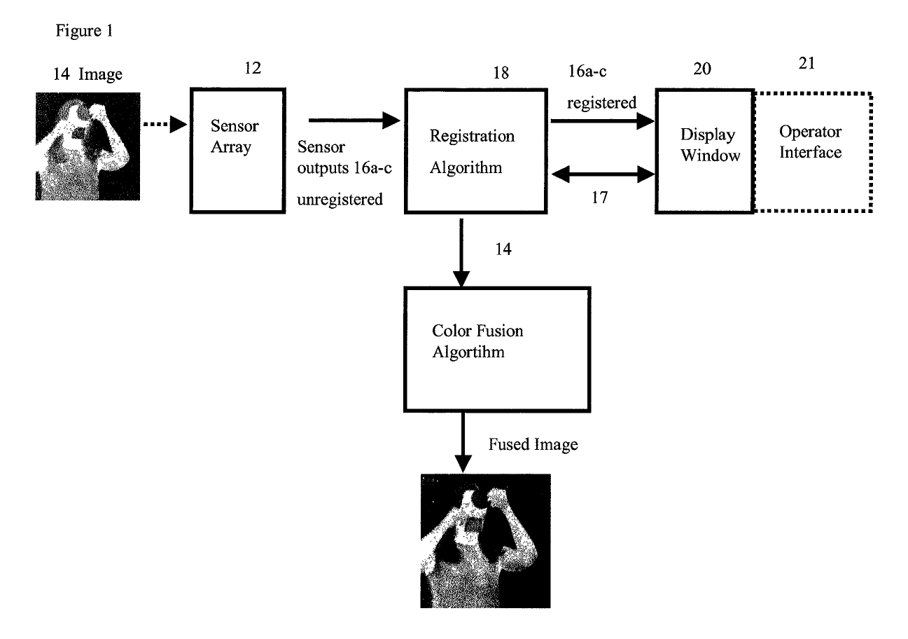

Referring now to FIG. 1, which shows the flow of data from the sensor to the image display, in FIG. 1 a multi-spectral color fusion system 10 includes sensor array 12, independently sensitive to different spectral bands, for acquiring image 14 and producing analog or digital image outputs 16a, b, c, each representing a different spectral band.

Because image outputs 16a-c are produced by different sensors, or sensor areas, these are then scaled to match their individual pixel fields of view (IFOVs) in order to subsequently register and fuse the images with a registration algorithm 18, a component of a software program that runs on a computer and that includes both registration algorithm 18 and a color fusion algorithm 24. Registration algorithm 18 is preferably an affine transformation, that is, a multiplication of an image output by a registration matrix, the values of which are available to the software, that results in the translation, magnification, and rotation, (i.e., the “scaling”), of that output 16a, b, or c to match another output 16a, b, or c. The outputs 16a-c are registered to a common field of view, permitting the use of sensors that do not have to rely on common optics, e.g. sensors spanning a wide range of wavelengths for which common optics may not presently exist. The fields of view (FOV) of outputs 16a-c are matched as closely as possible to minimize the amount of data discarded by clipping. Once clipped to the same field of views, outputs 16a-c are registered to match pixel-by-pixel and displayed on display window 20.

The values used by the registration algorithm 18 are set during a calibration procedure in which outputs 16a-c are displayed on a monitor 20, registration preferably being accomplished by an operator using operator interface 21. Sensor array 12 stares at a stationary scene, preferably including sharp edges in the different spectral bands. One image output 16 a, b, or c is chosen as the basis image while another image 16a, b, or c is warped to match. The registration matrix is adjusted, using the GUI interface, until the second image aligns with the basis image. When using more than two sensor areas or cameras, outputs 16a-c are all registered to a common basis image. The registration matrix is used to create a pixel map, in the form of a lookup table, between the raw image to a registered version of the image. The lookup table correlates pixels in the registered image to the pixel that is nearest to the theoretical point in the raw image. A preliminary registered image 17 is then displayed on display window 20, allowing the area of the fused image in which the basis image and the registered second image do not overlap to be clipped by an operator at a workstation to obtain registered image outputs 22a-c. The calibration need only be done once and is valid as long as the individual sensor elements comprising sensor array 12, e.g. cameras or sensor areas as is further described below, remain in fixed positions with respect to each other. Operator interface 21 allows the operator to choose to write this registration matrix to a file on the computer hard drive to be reloaded at a later time.

The operator's input is helpful in the registration process because it is preferable to exercise some thought and discretion in selecting which image to use as the basis image. Although it is possible to choose otherwise, the image with the best resolution (i.e. smallest IFOV) is usually the best candidate. In some instances, one pixel in the raw second image may be mapped to two, or more, pixels in the registered second image. However, preferably every pixel in the raw second image is represented by at least one pixel in the registered second image, with the exception of pixels from the raw image that map to positions outside of the overlapping areas of the registered second image and the basis image. In the various camera combinations used in the examples described below, a pixel in the raw image mapped to a maximum number of two pixels in the registered image.

Another advantage of selecting the image from the camera with the smallest IFOV as the basis image is that aliasing problems can be eliminated or minimized. The selection of a larger IFOV can result in only one pixel of two adjacent pixels in the raw image being mapped to a pixel in the registered image. This can, for example, in the situation of flickering from a strobe light that is recorded within the odd fields of image produce a resulting image that appears banded, even though in the raw image containing both odd and even fields the strobe light was not apparent.

After registration, registered image outputs 22a-c are input to a color fusion algorithm 24 that calculates a color-fused output image 26 based on input data/outputs 22a-c. In an embodiment of the invention that we term “Simple Color Fusion” (SCF), algorithm 24 takes outputs 22a-c and assigns these to the colors in display 20, red, green or blue, based on their respective wavelengths. The algorithm 24 maps the longest wavelength of outputs 22a-c to red, the shortest to blue, and the intermediate to green, where three outputs 22a-c are generated from three independent sensor-derived outputs 16a-c. Although the assignment of bands to colors is most often fused according to their wavelength, it should be understood that any band or any combination of bands can go to any color.

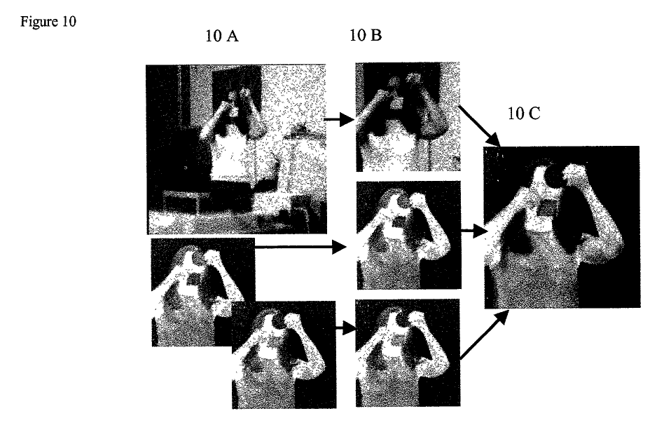

In a preferred embodiment of the invention that we term “Principle Component Color Fusion” (PCCF), algorithm 24 takes outputs 22a-c and creates a fused image 26. Often the pixel values from the single band images are correlated and tend to make an oval (football-shaped) distribution when plotted in a two (three) dimensional color space. It is advantageous to rotate the distribution into a coordinate frame that takes advantage of this fact. A three-band color space is shown in FIG. 10. The top left section of FIG. 10 shows a red, green, blue Cartesian space. The brightness direction is the (1,1,1) axis in the red, green, blue Cartesian space. The bottom right part of the figure shows the chromaticity plane of the cylindrical-like hue, saturation, and value space. A distribution of pixel values is represented as a prolate spheroid extending along the principal component direction. The principle component direction is the direction of the first eigenvector of the distribution. PCCF takes each pixel value, a vector of red green and blue values, and rotates it into the coordinate frame in which the principle component of the distribution aligns with the brightness direction. The chromaticity plane being orthogonal to this direction. (Although, there are some cases where it is advantageous to align the brightness direction orthogonal to the principle component direction and the principle component direction in the chromaticity plane.) The chromaticity plane is either described in polar coordinates (hues being from 0 to 360 degrees and saturation being a positive value in the radial direction) or in rectangular coordinates (chrominant axes 1 and 2, sometimes described as the red-green and the yellow-blue directions). The polar coordinate representation is often referred to as hue, saturation, and value (HSV), where value (brightness) is taken to be the principal component direction. Rotating the data into this transform space, with one axis being a principle component direction, is very useful because it allows the chrominant and brightness information to be processed in a separable manner.

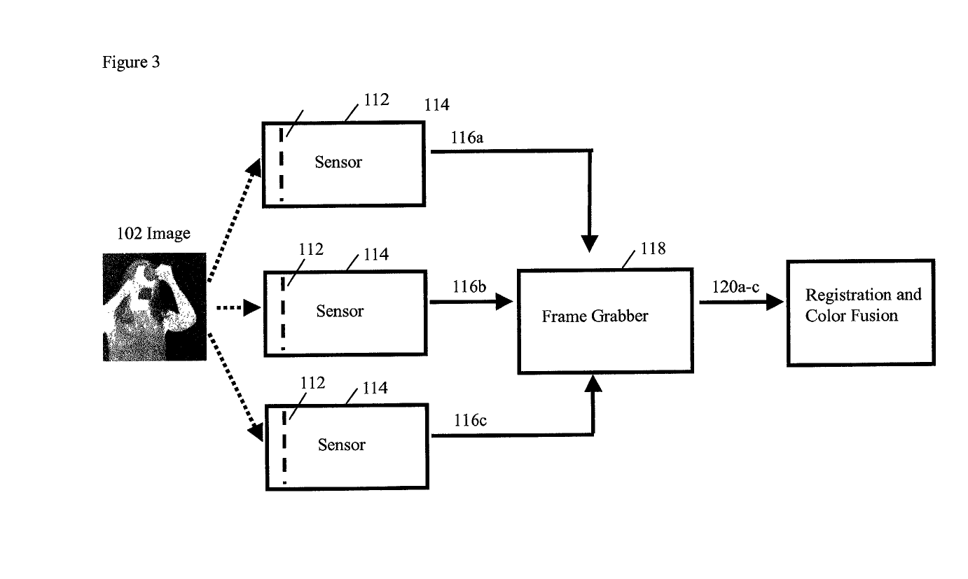

Referring now to FIG. 3 illustrating a color fusion system 100 in accordance with the invention, image 102 is independently acquired by each sensor area 112 located on a sensor 114, each sensor area 112 being sensitive to a different spectral band than another sensor area 112 and generating an image output 116a-c. Although three sensor areas 112 are shown, as few as two sensor areas 112 may be used in the practice of the invention. The different spectral bands can be in the visible spectrum, the non-visible, or any combination desired for a particular application. Although sensor areas 112 are shown located on separate sensors 114, alternatively one or more sensor areas 112 may be positioned on one such sensor 114, e.g. in a layered configuration that allows radiation to pass through a top sensor layer and enter an underlying sensor area. Image outputs 116a, b, and c may be analog, may be digital, as with a digital camera having a CCD-type sensor area 112, or a combination of analog and digital. The cameras may have different fields of view, pixel formats, and frame rates and the like.

Outputs 116a-c are input to one or more frame grabbers 118 which allow the collection of camera pixel intensities into a frame of data. The preferred framegrabbers are Imaging Technologies IC-PCI motherboards with an attached a daughter board, either a AM-FA, AM-VS and AM-DIG. These framegrabbers are configured with software specific to this product. The Imaging Technology software allows a file to be created, and read during use of the framegrabber, in which values particular to individual cameras are stored. As shown, one frame grabber 118 receives outputs 116a-c and provides a digital output 120a-c representative of each respective sensor output 116a-c. Outputs 120a-c are next registered and color fused as described above.

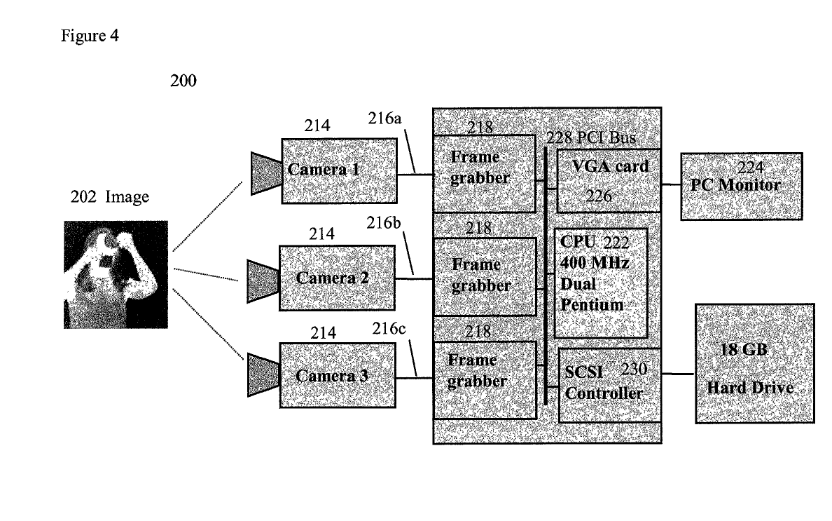

Referring now to FIG. 4, real-time color fusion system 200 includes three cameras 214 that independently acquire an image 202 in a different spectral band and as previously described produce unregistered independent outputs 216a-c, which again may be analog, digital, or both, representative of each different spectral band. For instance, camera 1 could be selected to be sensitive to visible light, camera 2 to SWIR, and camera 3 to LWIR. Each of outputs 216a-c is input to a separate frame grabber 218 that as described above generates independent outputs 220a-c representative of the different spectral bands, i.e. visible, SWIR, and LWIR, which are then input to CPU 222 and to monitor 224. The operator can then manipulate outputs 220a-c to accomplish registration as described above, and carry out real-time color fusion. A video card 226 is a commonly used piece of hardware used to control the data stream from a PCI bus 228 to monitor 224.

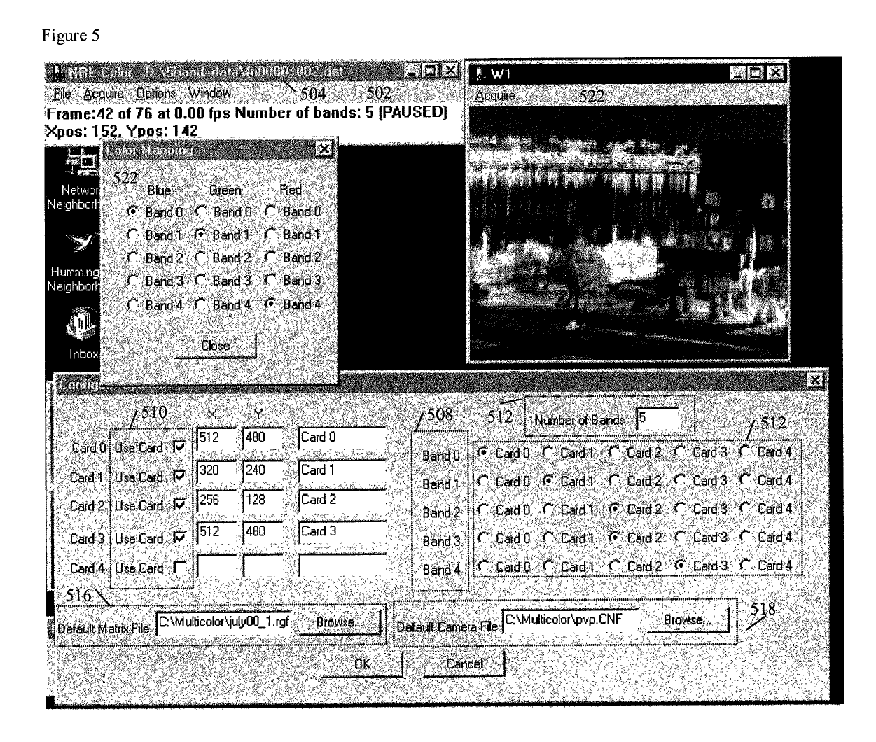

The results of system 200 are shown in FIG. 5, which illustrates an operator interface of the software program that runs on the computer CPU and executes the registration and color fusion algorithms. This operator interface dialogue boxes and color fusion image box would be displayed on monitor 224. In the very upper left hand corner is the Main Menu dialogue box 502, entitled “NRL Color”—with the menu options: File, Acquire, Options and Window. If stored data is being replayed from a hard disk, the name of the data file is listed next to the dialogue box title. In the example in the figure, a stored file 504 with the name “D:/5band_data/fri0000_{—}002.dat” is opened. In the lower half of the figure is a dialogue box 506 entitled “Configure System” used to associate the frame grabber, here called ‘Card’, to an image output 508, here called ‘Band’. This dialogue box 506 is opened by the operator under the Main Menu item “Options”. A checkbox 510 exists to indicate if a Card is to be queried by the software program. The number of pixels of the output in two dimensions, x and y, can be entered into the dialogue box. The number of Bands is entered in the top right 512 of the dialogue box 506. A matrix checkbox 514 exists that allows the software to associate the Band (output) to a Card (framegrabber). Each Card can provide data to at least one Band. A default matrix file 516, created in the calibration process described above, that is stored in a file on the computer can be opened and the values of the registration matrix can be automatically entered into the software by listing that file in the bottom left entry line of the dialogue box. A Default Camera File 518 also can be opened and read by the software. The information in this file specifies characteristics particular to individual cameras, such as those shown in FIG. 3, and this information necessary is specific to the preferred framegrabbers. In the upper left hand corner is a dialogue box 520 entitled “Color Mapping” of the operator interface that allows the Band to be associated with a color. One band can be associated with one, two, three or no colors. In the upper right hand of the figure is a color fusion image display box 522, “W1”. This box is opened from the Window menu option of the Main Menu 502. The image in the box in this example is a 3-color fused image of Low Light Level Visible, SWIR and LWIR camera imagery.

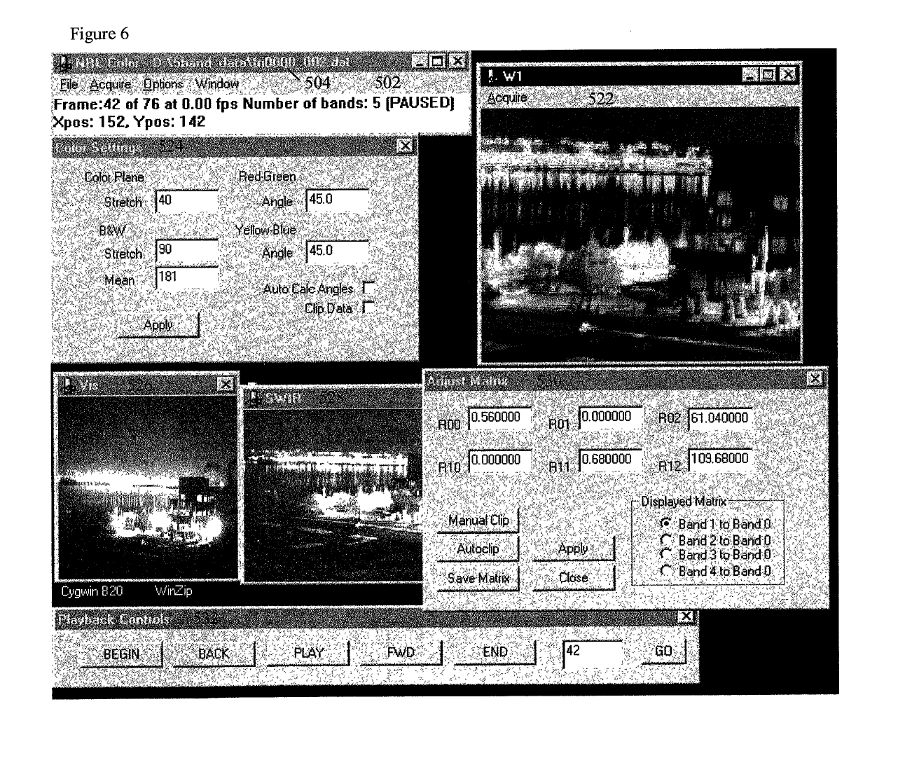

FIG. 6 also illustrates part of the operator interface and the color fusion image display box results of system 200 on monitor 224. Again the Main Menu dialogue box 502 is in the upper left hand corner. The box 524 below the Main Menu is entitled ‘Color Setting” and allows a factor to be entered, Color Plane Stretch, that multiplies the pixel distribution in the chromaticity plane causing the average saturation value to increase or decrease. A multiplicative factor “B&W Stretch” can be entered which increases or decreases the standard deviation of the distribution in the brightness direction. The mean pixel distribution in the brightness direction can also be adjusted. The red-green and yellow-blue angles of rotation of the distribution can also be fixed in the software instead of the software calculating a principle component direction. The box “Auto Calc Angles” allows the principle component angle of the distribution to be calculated for each frame. The box “Clip Data” allows the software to automatically delete any area of the color fused image that has zero values in more than one Band, automatically finding the region of overlap between the Bands outputs. The image display boxes 526 and 528 “VIS” and “SWIR”, respectively, each display one of the individual outputs after scaling but before color fusion. This information is diagnostic, allowing the operator to examine the output separately before the color fusion step. The dialogue box 530 of the operator interface entitled “Adjust Matrix” is used to input the rotation matrix that allows the outputs to be registered to a basis image output, here called Band 0. A check box on the bottom right of this dialogue box is used to check which rotation matrix is displayed in the entry lines. The rotation matrix is a 3 by 3 matrix, with matrix elements R00 through R22. The matrix elements R00, R01, R10, and R11 affect the magnification of the unregistered image to the registered image. The matrix elements R02 and R12 affect the translation of the unregistered image to the registered image. The elements R20 and R21 are always 0.0 and do not need to be adjusted, so they are not shown. The element R33 is always 1.0, so it is also not shown. As in FIG. 5, “W1” box 522 displays a 3-color fused image. In the bottom of the figure is a dialogue box 532, “Playback Controls”, that allows the operator to enter in to the software commands for manipulating a data file stored on hard disk that has been opened. These commands include “Begin” which starts the display of the image sequence, both in the individual output display boxes 526 and 528 (“VIS” and “SWIR”), and in the color fusion display box 522 (“W1”).

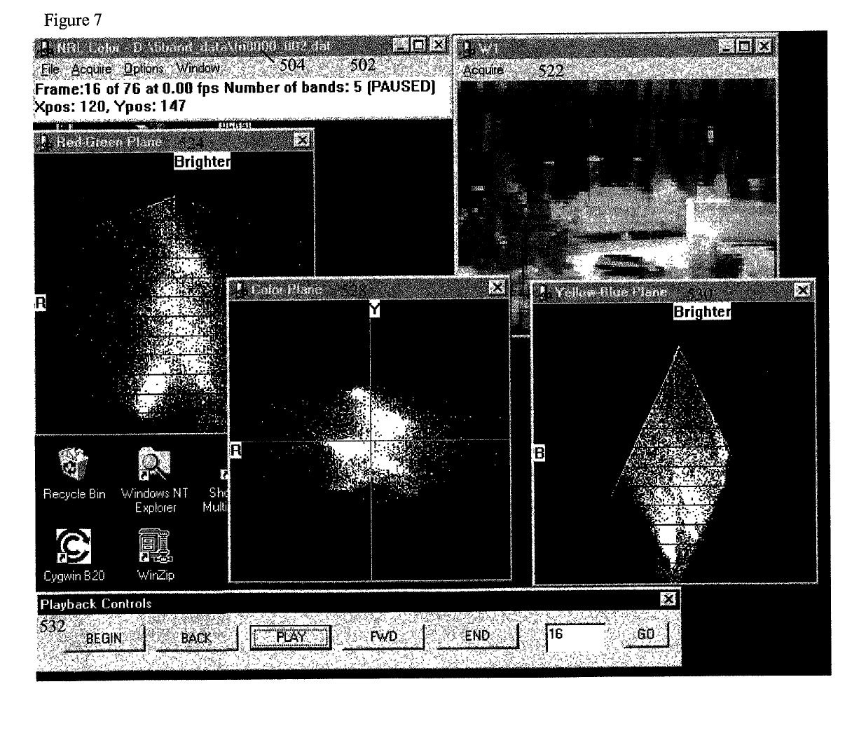

Again showing the results of system 200 on monitor 224, FIG. 7 shows the Main Menu 502, the “Playback Control” dialogue box 532, the color fusion display window 522 (“W1”), and three additional display boxes 534, 536, and 538. These boxes display the values of the pixel distribution in two dimensional space. These plots are commonly called “scatter plots”. The display box 536 entitled “Color Plane” displays the pixel values in the chromaticity plane. The chromaticity plane includes two perpendicular lines named “R-G” for red-green and “Y-B” for yellow-blue. The third axis is the Brighter-Darker axis. The display box 534 labeled “Red-Green Plane” shows a plane that includes the Brighter-Darker line and the R-G line, looking at the plane from the blue side of the “YB” line. The display box 538 labeled “Yellow-Blue Plane” shows a plane that includes the Brighter-Darker Line and the “Y-B” line. These display boxes are important to use for diagnostic to understand how individual pixel values affect the color fused image. The pixel values of individual objects in the image that are very different from the other objects in the image can be seen in these scatter plots as groups of pixel values that separate from the main distribution.

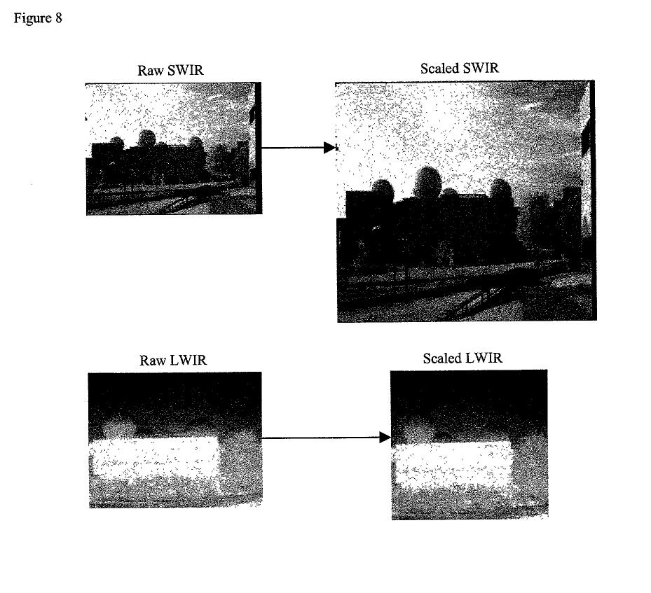

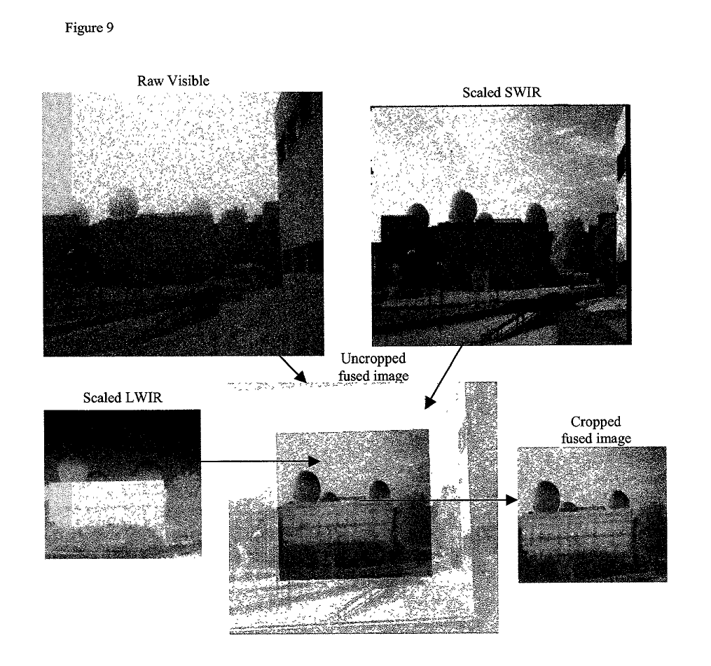

FIGS. 8-10 illustrate the result produced by system 200 using registration and using algorithm 24. In FIG. 8, the images labeled “Raw SWIR” and “Raw LWIR” are scaled as described above so that their individual pixel FOVs match the individual FOV of the third, visible spectrum camera to which they are being registered in FIG. 9. System 200 was tested and the result of the registration algorithm is shown in FIG. 10, in which a visible image is registered to the 128×128 images from a dual-band stacked focal plane array (FPA) sensor made of HgCdTg metals sensitive to two different mid-wave bands. In a dual-band stacked focal plane array, each pixel is sensitive to both bands. The data is read separately for each band making two images. These image are essentially “registered in hardware”, so if one of the dual-band FPA images is used as the basis image and only these images are fused, the registration calibration step in the color fusion processing, can be skipped, providing an advantage in computational speed. The figures also illustrate the results of color fusion using algorithm 24. The filters held by the person are very similar shades of gray in the monochrome images. The slight differences of the shades of gray of the filters between the three bands is emphasized as bright differences in color in the final three-color fused image. As shown in FIG. 9, once the FOVs of the images are all the same, these are combined into a fused image 228 that is cropped to include just the clearest portion where the FOVs of the three cameras overlap. FIG. 10 shows real-time registration, in which raw visible image 10A is registered to match the IR dual band MW-MW image so all three can be fused. 10B is the clipped and registered VIS. The registration matrix is created in a calibration step as described above. A look-up table that maps pixels in the raw image to pixels in the registered image is generated from the registration matrix. 10C is the resultant three-color fused image. Individual pixels of the raw visible image can be mapped to one or more pixels in the registered image, or not included. Pixel interpolation is optional, and as shown is not applied. The wall and background are contributed to the fused image by the visible band. The filters being held have different absorption properties in the infrared, which is slightly apparent as shades of gray in the single image bands. The data is processed so that the difference is readily apparent in the fused image.

Special Cases: Monochrome Fusion and Two-color Fusion

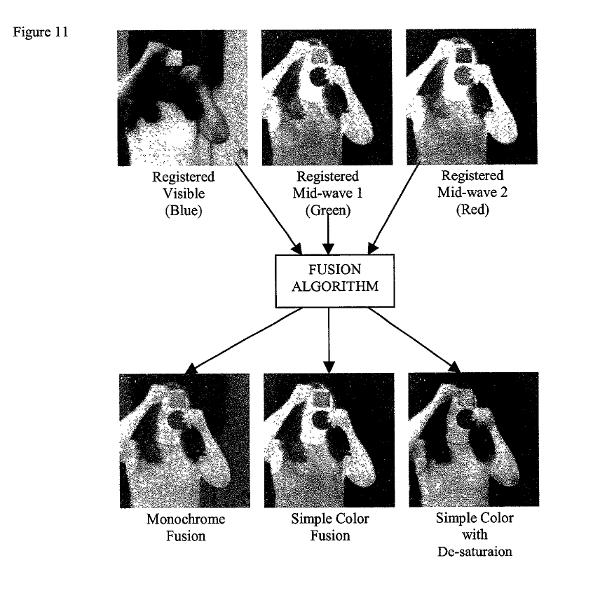

FIG. 11 shows a comparison of results of application of three different fusion processing algorithms 26. The person is holding two filters. The square filter transmits better in mid-wave IR 1 than in mid-wave IR 2 and is opaque in the visible band. The circular filter transmit better in mid-wave IR 2 than in mid-wave IR 1 and is transparent in the visible band. When the images are combined using monochrome fusion, all of this information is lost. Simple color fusion shows that the filters transmit differently in the two mid-wave IR bands, but the image is still dominated by the person who is still bright in all three bands. Simple color fusion with de-saturation emphasizes the difference between the two filters. The person does not appear as colorfully as the filters, because there is little difference in her image between the three bands. Other algorithms and image processing algorithms such as red enhancement, differencing and gamma stretching are also included in the color fusion algorithm 26 according to the invention.

As shown in the dialogue box 520 in FIG. 5, one output of system 200 can be directed to two colors in the final color fusion display, so that one band can be shown in two colors, e.g. blue and green which combine to make the one color cyan, and a second output can be shown in one color, e.g. red, so that the resulting color fusion image in 224 has only two colors, cyan and red.

The final step of the software is to display the color fused imagery in a display box, e.g. box 522, on monitor 224. Multiple such display boxes can be viewed at one time. There is a menu on each such display box that allows the user to set the fusion algorithm to be viewed in that box, so that the results of multiple separate fusion algorithms can be viewed at one time.

Obviously many modifications and variations of the present invention are possible in the light of the above teachings. It is therefore to be understood that the scope of the invention the invention should be determined by referring to the following appended claims.

I claim:

1. An image processing apparatus for processing imaging data in a plurality of spectral bands and fusing the data into a color image, comprising:
one or more imaging sensors;
at least two image-acquiring sensor areas located on said one or more imaging sensors, wherein each said sensor area is sensitive to a different spectral band than at least one other of said sensor areas and generates an image output representative of an acquired image in the spectral band to which the sensor area is sensitive;
a registration algorithm for scaling and registering said image outputs; and
a color fusion algorithm for combining said image outputs into a single image.

2. An apparatus as in claim 1, further comprising a frame grabber.

3. An apparatus as in claim 1, wherein said registration algorithm and said color fusion algorithm are resident programs in a central processor of a general purpose computer.

4. An apparatus as in claim 1, further comprising a screen display.

5. An apparatus as in claim 4, further comprising an operator interface for allowing operator input in processing of said image outputs.

6. An apparatus as in claim 1, wherein said color fusion algorithm is SCF.

7. An apparatus as in claim 1, wherein said color fusion algorithm is PCCF.

8. An apparatus as in claim 7, wherein said PCCF de-saturates said fused output image.

9. An apparatus as in claim 1, further comprising one or more additional sensors on which some of said plurality of imaging sensor areas are located.

10. An apparatus as in claim 1, wherein said apparatus is configured to acquire images in real time.

11. An apparatus as in claim 1, wherein said plurality of sensors comprises three sensors, and each said sensor is configured to map its image to an associated color channel, and wherein said algorithm is configured to combine said color channels into a color image.

12. An apparatus as in claim 11, wherein said three sensors are respectively sensitive to the visible, LWIR, and SWIR spectral bands.

13. An apparatus as in claim 1, wherein said processing and fusing of said image occurs in real time.

14. A method for producing a real-time color fused image, comprising te steps of:
providing one or more imaging sensors including at least two image-acquiring sensor areas located on said one or more imaging sensors, wherein each said sensor area is sensitive to a different spectral band than at least one other of said sensor areas;
exposing said at least two sensor-areas to an image, said at least two sensor areas thereby each acquiring said image and generating and generating an image output representative of said acquired image in the spectral band to which the sensor area is sensitive;
scaling said image outputs of said sensor areas;
registering said image outputs; and
color fusing said image outputs into a single image.

15. A method as in claim 14, further comprising the step of providing a frame grabber for acquiring said image.

16. A method as in claim 14, wherein said registration algorithm and said color fusion algorithm are resident programs in a central processor of a general purpose computer.

17. A method as in claim 14, further comprising displaying said image outputs on a screen display.

18. A method as in claim 17, further comprising providing an operator interface for allowing operator input in processing of said image outputs.

19. A method as in claim 14, wherein said color fusing is SCF.

20. A method as in claim 14, wherein said color fusing is PCCF.

21. A method as in claim 14, wherein said image is acquired by three sensors, each said sensor is configured to map its image to an associated color channel, and wherein said fusing combines said color channels into a color image.

22. A method as in claim 14, wherein said three sensors are respectively sensitive to the visible, LWIR, and SWIR spectral bands.

23. A method as in claim 14, wherein said processing and fusing of said image occurs in real time.
